(19) United States
(12) Patent Application Publication
(10) Pub. No.: US 2011/0154273 A1
(43) Pub. Date: Jun. 23, 2011

(54) METHOD OF GENERATING MASK PATTERN, MASK PATTERN GENERATING PROGRAM, AND METHOD OF MANUFACTURING SEMICONDUCTOR DEVICE

(76) Inventors: Ryota ABURADA, Kanagawa (JP); Toshiya Kotani, Tokyo (JP)

(21) Appl. No.: 12/964,185

(22) Filed: Dec. 9, 2010

(30) Foreign Application Priority Data
Dec. 18, 2009 (JP) 2009-287716

(51) Int. Cl. G06F 17/50

(52) U.S. Cl. 716/52

(57) ABSTRACT

According to one embodiment, in process simulation, it is verified whether sidewall patterns formed on sidewalls of a core material pattern or a transfer pattern formed by transferring the core material pattern form a closed loop. When it is determined as a result of the verification that the sidewall patterns form a closed loop, the mask pattern is changed. When it is determined as a result of the verification that the sidewall patterns do not form a closed loop, the mask pattern is adopted.

### CROSS-REFERENCE TO RELATED APPLICATIONS

This application is based upon and claims the benefit of priority from the prior Japanese Patent Application No. 2009-287716, filed on Dec. 18, 2009; the entire contents of all of which are incorporated herein by reference.

### FIELD

Embodiments described herein relate generally to a method of generating a mask pattern, a mask pattern generating program, and a method of manufacturing a semiconductor device.

### BACKGROUND

In recent years, according to microminiaturization of semiconductor elements, there is a demand for a method of forming a pattern having a dimension smaller than an exposure resolution limit of the photolithography method. As one method of forming such a pattern, there is known a method of manufacturing a semiconductor device for forming sidewall patterns on sides of a slimmed dummy pattern (core material) and performing processing of a film to be processed using, as masks, the sidewall patterns left by removing the dummy pattern.

With the method of manufacturing a semiconductor device, after the formation of the sidewall patterns, the dummy pattern is removed, an end of a closed loop formed by the sidewall patterns are cut by the photolithography method, and the film to be processed is processed using the sidewall patterns, the end of the closed loop of which is cut, as the masks. This makes it possible to form a pattern having a dimension smaller than the exposure resolution limit of the photolithography method.

However, in the method of manufacturing a semiconductor device in the past, because the closed loop is cut, a step of cutting the end of the closed loop using the photolithography method is necessary. In particular, from the viewpoint of cost for manufacturing a semiconductor device, a further reduction of steps is requested.

### BRIEF DESCRIPTION OF THE DRAWINGS

FIG. 1 is a block diagram of a computer that executes a computer program according to a first embodiment;

FIG. 2 is a schematic diagram of the structure of the computer program according to the first embodiment;

FIG. 3 is a schematic diagram of a photomask manufactured based on mask pattern data;

FIG. 4 is a sectional view of an end of a transfer pattern;

FIGS. 5A to 5I are schematic diagrams for explaining a pattern forming method according to the first embodiment;

FIGS. 6A to 6E are schematic diagrams for explaining the optical image intensity and the shape of a pattern end according to the first embodiment;

FIGS. 7A to 7K are schematic diagrams for explaining the optical image intensity and the shape of the pattern end according to the first embodiment;

FIG. 8 is a flowchart for explaining a method of generating a mask pattern according to the first embodiment;

FIG. 9A is a graph concerning the position and the optical image intensity of the transfer pattern and a main part sectional view of the transfer pattern;

FIG. 9B is a top view of the transfer pattern;

FIGS. 10A to 10F are main part sectional views for explaining a process for manufacturing a semiconductor device using a photomask according to the first embodiment; and

FIG. 11 is a flowchart concerning a method of manufacturing a mask pattern according to a second embodiment.

### DETAILED DESCRIPTION

In general, according to one embodiment, a core material pattern is acquired from layout data of a circuit pattern. In process simulation, any one of the core material pattern, a transfer pattern formed by transferring the core material pattern, and sidewall patterns formed on sidewalls of the core material pattern or the transfer pattern is calculated. A mask pattern for forming the core material pattern is used for the process simulation. It is verified by the process simulation whether the sidewall patterns formed on the sidewalls of the core material pattern or the transfer pattern form a closed loop. When it is determined as a result of the verification that the sidewall patterns form a closed loop, the mask pattern is changed. When it is determined as a result of the verification that the sidewall patterns do not form a closed loop, the mask pattern is adopted.

Exemplary embodiments of a method of generating a mask pattern, a mask pattern generating program, and a method of manufacturing a semiconductor device will be explained below in detail with reference to the accompanying drawings. The present invention is not limited to the following embodiments.

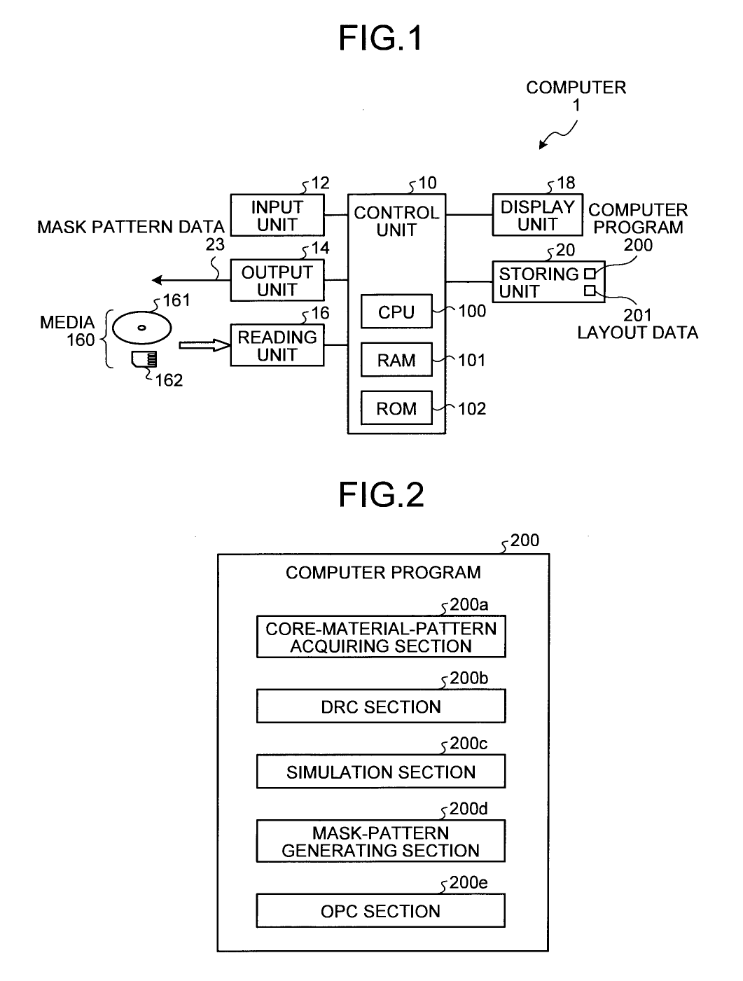

FIG. 1 is a block diagram of a computer that executes a computer program according to a first embodiment. This computer 1 schematically includes, for example, as shown in FIG. 1, a control unit 10, an input unit 12, an output unit 14, a reading unit 16, a display unit 18, and a storing unit 20. The storing unit 20 stores a computer program 200 and layout data 201.

The control unit 10 schematically includes, for example, a central processing unit (CPU) 100, a random access memory (RAM) 101, and a read only memory (ROM) 102.

For example, the CPU 100 reads out the computer program 200 from the storing unit 20, causes the RAM 101 to temporarily store the computer program 200, and executes processing based on the computer program 200.

The RAM 101 is, for example, a volatile memory that temporarily stores the computer program 200 read out by the CPU 100, calculated data, and the like.

The ROM 102 is, for example, a nonvolatile memory that stores a computer program necessary for the basic operation of the computer 1.

The input unit 12 includes, for example, input terminals such as universal serial bus (USB) terminals. Input devices such as a keyboard and a mouse are connected to the input terminals.

The output unit 14 includes, for example, output terminals such as USB terminals. An external storage device, an external apparatus, and the like are connected to the output terminals. The output unit 14 outputs mask pattern data 23 explained below.

The reading unit 16 can read data stored in, for example, media 160 including an optical disk 161 such as a compact disc read only memory (CD-ROM) or a digital versatile disk read only memory (DVD-ROM) having stored therein the computer program 200 and the layout data 201 and a memory card 162 including a semiconductor memory.

The display unit 18 is, for example, a liquid crystal display and displays a result or the like calculated by the CPU 100.

The storing unit 20 includes, for example, a hard disk (HD). The layout data 201 stored in the storing unit 20 is, for example, data concerning the width, the height, the interval, and the like of a circuit pattern. The layout data 201 in this embodiment is stored in the storing unit 20. However, the layout data 201 can be acquired via the input unit 12 or can be acquired from the reading unit 16 via the media 160. A method of acquiring the layout data 201 is not limited to these. The computer program 200 can be stored in the storing unit 20 or the ROM 102 in advance.

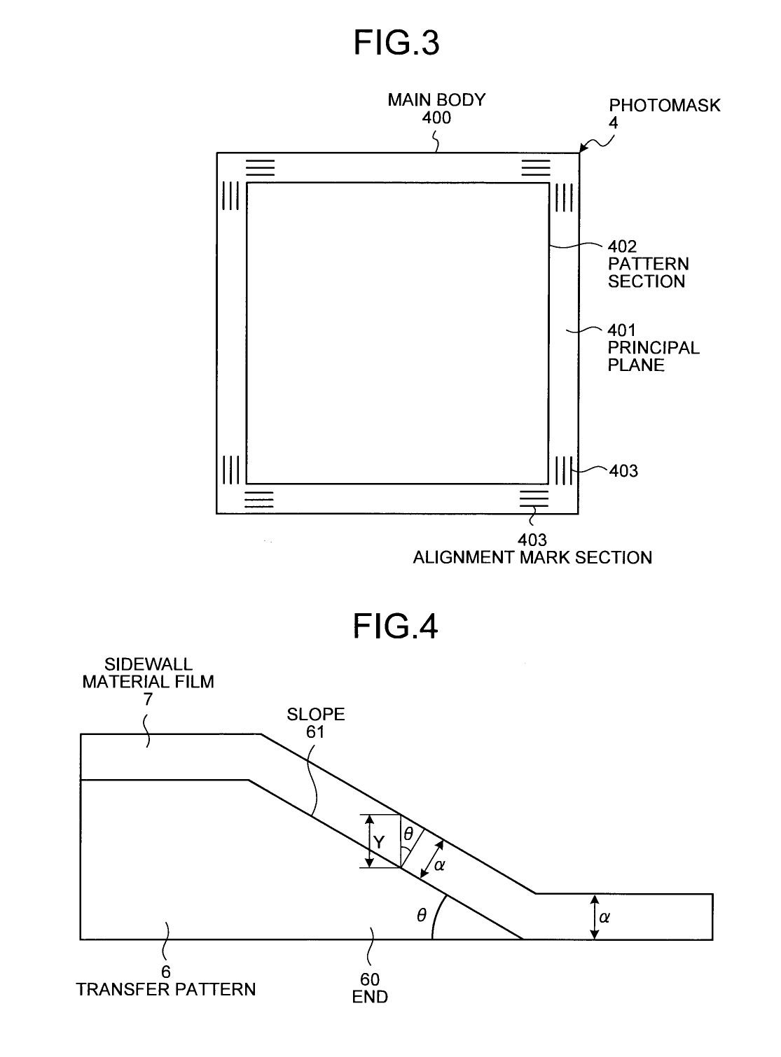

FIG. 2 is a schematic diagram of the structure of the computer program according to the first embodiment. This computer program 200 schematically includes, for example, as shown in FIG. 2, a core-material-pattern acquiring section 200a, a design rule check (DRC) section 200b, a simulation section 200c, a mask-pattern generating section 200d, and an optical proximity correction (OPC) section 200e. For example, not all of the core-material-pattern acquiring section 200a, the DRC section 200b, the simulation section 200c, the mask-pattern generating section 200d, and the OPC section 200e have to be included in the computer program 200. The core-material-pattern acquiring section 200a, the DRC section 200b, the simulation section 200c, the mask-pattern generating section 200d, and the OPC section 200e can be respectively included in independent computer programs. The independent computer programs can be collectively provided.

For example, the core-material-pattern acquiring section 200a acquires a core material pattern from the layout data 201 of a circuit pattern. Because the circuit pattern is formed by processing a film using sidewall patterns as masks, the circuit pattern corresponds to the sidewall patterns. Because the core material pattern is a core material of the sidewall patterns, the core-material-pattern acquiring section 200a acquires a pattern to be a core material of the circuit pattern as a design core material pattern.

The DRC section 200b determines, for example, whether the core material pattern acquired from the core-material-pattern acquiring section 200a conforms to design rules.

The simulation section 200c executes, for example, simulation for calculating the acquired core material pattern, a transfer pattern formed by transferring the core material pattern to a transfer target, or sidewall patterns formed on sidewalls of the core material pattern or the transfer pattern. The simulation section 200c verifies whether the sidewall patterns form a closed loop at ends of the sidewall patterns. The closed loop means that the sidewall patterns are connected to each other across the core material pattern or the transfer pattern.

When the sidewall patterns do not form a closed loop at the end of the core material pattern or the transfer pattern, this means that, for example, the end of the core material pattern or the transfer pattern has a shape in which a closed loop is cut by etch-back in formation of the sidewall patterns (e.g., a taper shape explained later).

Conditions under which the sidewall patterns do not form a closed loop at the end of the core material pattern or the transfer pattern are calculated by, for example, changing an optical proximity effect on the end of the core material pattern, arrangement of auxiliary patterns explained later, the number and the shape of the auxiliary patterns, and the like.

The simulation section 200c determines whether a closed loop is cut according to, for example, whether the sidewall patterns do not form a closed loop at the end of the core material pattern, i.e., the end of the core material pattern is formed in the shape for cutting a closed loop.

In the simulation, it is necessary to prepare a mask pattern for forming the core material pattern. The mask-pattern generating section 200d generates the mask pattern. In the mask pattern generation, the OPC section 200e applies OPC processing (including generation of the auxiliary patterns). Specifically, for example, to control an optical proximity effect in which a pattern shape deviates from a desired pattern shape because of proximity of mask patterns, the OPC section 200e forms a fine correction pattern and adds the formed correction pattern to the mask pattern data 23 to correct the mask pattern data 23.

The simulation section 200c simulates, based on the generated mask pattern, a process for forming the core material pattern through lithography. The simulation section 200c can further simulate various processes for forming the sidewall patterns on the sidewalls of the core material pattern. The core material pattern also includes a pattern formed by processing a core material pattern formed on a resist film by the lithography and transferring the core material pattern to a film in lower layer through etching.

When the closed loop is not cut as a result of the simulation, i.e., when the obtained core material pattern does not have a desired taper shape or when the closed loop of the obtained sidewall patterns is not cut, the simulation section 200c changes the mask pattern, for example, changes conditions such as an OPC condition and the arrangement of the auxiliary patterns and performs simulation of core material pattern formation or sidewall pattern formation again. For example, when the closed loop is not cut even if the simulation of the sidewall pattern formation is performed based on all conditions such as a predetermined number of times of change of the mask pattern and arrangement of effective auxiliary patterns, the simulation section 200c changes an acquisition condition and acquires the design core material pattern again via the core-material-pattern acquiring section 200a. The core material pattern acquisition condition is, for example, set thickness of the sidewall patterns. A set dimension of the core material pattern is changed as appropriate according to the thickness. A DRC condition of the DRC section 200b can be changed.

Further, for example, when the closed loop is not cut by the simulation of the sidewall pattern formation even if the acquisition condition is changed a predetermined number of times or all effective acquisition conditions are changed, the simulation section 200c changes the layout data 201. However, the mask-pattern generating section 200d can change the layout data 201 without necessarily changing the core material pattern acquisition condition and performing the verification again through the simulation. For example, when the closed loop is not cut, the simulation section 200c can change process conditions in the core material pattern formation and the sidewall pattern formation. The process conditions are, for example, lithography conditions (dose, focus, etc.) during the core material pattern formation, deposit thickness of a sidewall pattern material, and an etch-back amount during the sidewall pattern formation.

The mask-pattern generating section 200d generates, for example, the mask pattern data 23 of a photomask with which the end of the transfer pattern is formed in the shape for cutting the closed loop. Specifically, the layout data 201, the core material pattern acquisition condition, and the process conditions during the side wall pattern formation with which the end of the transfer pattern is formed in a shape for cutting the closed loop are verified by the simulation. The mask-pattern generating section 200d generates a mask pattern based on the verified various conditions.

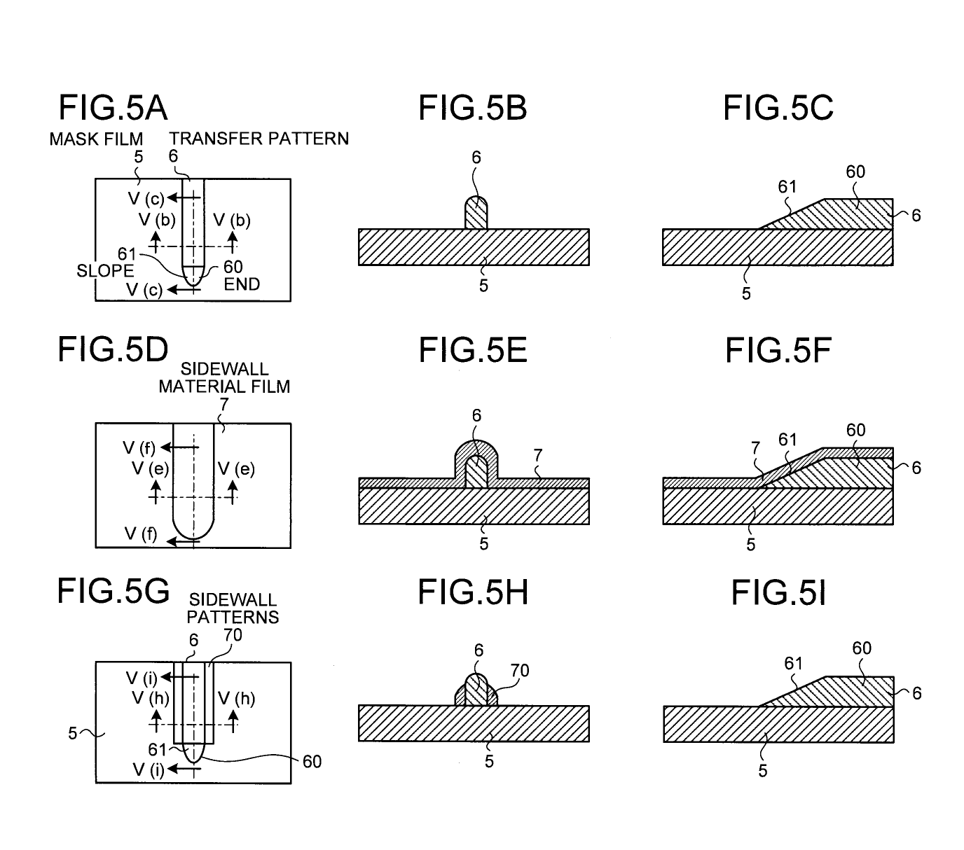

FIG. 3 is a schematic diagram of a photomask manufactured by a photomask manufacturing apparatus based on mask pattern data.

This photomask 4 schematically includes, for example, as shown in FIG. 3, a main body 400, a pattern section 402 formed on a principal plane 401, and alignment mark sections 403 formed around the pattern section 402.

The main body 400 is, for example, a transparent substrate made of glass or the like. On the principal plane 401 of the main body 400, for example, a light blocking film made of chrome, a phase shift film, or the like is formed. On the light blocking film, the pattern section 402 and the alignment mark sections 403 are formed. In the pattern section 402, a pattern for manufacturing a semiconductor device is formed.

The alignment mark sections 403 are used for, for example, alignment of a semiconductor substrate and the photomask 4 in manufacturing the semiconductor device.

Manufacturing of the photomask 4 is performed by, for example, forming a light blocking film on a transparent substrate and patterning, using the photolithography method, the light blocking film based on the mask pattern data 23 created by the computer 1.

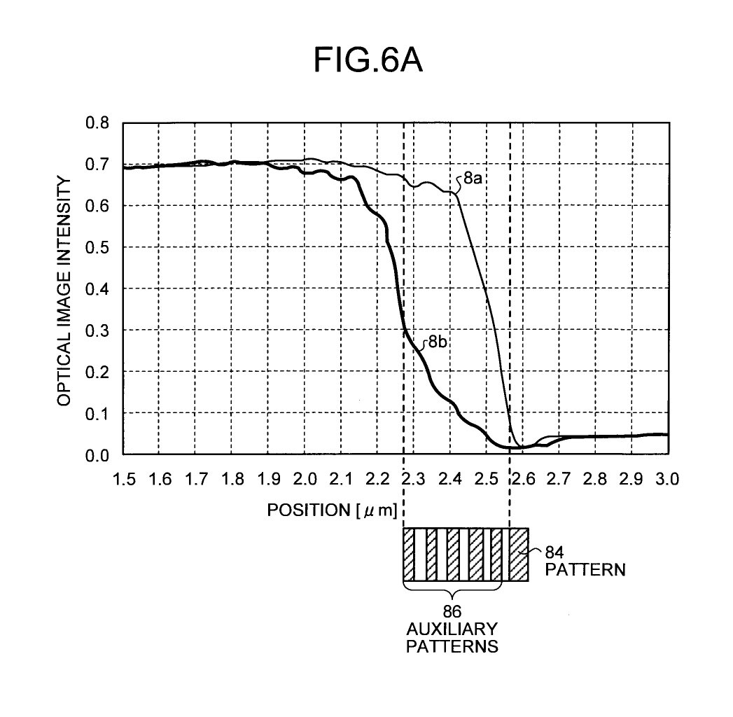

FIG. 4 is a sectional view of an end of a transfer pattern. In FIG. 4, hatching processing of a transfer pattern 6 and a sidewall material film 7 is omitted for explanation. The transfer pattern 6 is formed by transferring a core material pattern formed on a photomask. However, the transfer pattern 6 can be the core material pattern.

As a method of forming sidewall patterns around the transfer pattern 6, for example, there is known a method of forming the sidewall material film 7 to cover the transfer pattern 6 using the chemical vapor deposition (CVD) method or the like and etching back the formed sidewall material film 7 by the thickness of the formed sidewall material film 7 to form sidewall patterns. It is known that the sidewall patterns form a closed loop.

When the sectional shape of an end 60 of the transfer pattern 6 is a shape having a slope 61 as shown in FIG. 4, thickness Y in the vertical direction of the sidewall material film 7 formed on the slope 61 is represented as α×cos⁻¹ θ. In other words, the sidewall material film 7 on the slope 61 and the semiconductor substrate is removed and the closed loop is cut near the distal end of the end 60 by etching back the sidewall material film 7 by the thickness Y.

When the slope 61 or the like is not formed at the end 60, an etch-back amount in forming the sidewall patterns is α. When an etch-back amount necessary for removing the sidewall material film 7 on the slope 61 is represented as a×α, the following Formula (1) holds because the etch-back amount only has to be equal to or larger than the thickness Y. However, a is smaller than 0 because the thickness Y is larger than the thickness α.

a×α>Y=α×cos⁻¹ θ (1)

In the etch-back, the height of the sidewall patterns formed on sidewalls of the transfer pattern not in the slope forming section also decreases. Therefore, if the etch-back amount is large and the height of the sidewall patterns is small, when a lower layer film is etched using the sidewall patterns as masks in a later process, mask resistance of the sidewall patterns falls and a desired process of the processing cannot be realized. Therefore, for example, the height of the sidewall patterns before cutting the closed loop is set to about 1.4 times as large as the thickness of the sidewall material film 7. Further, a tilt angle θ of the transfer pattern is desirably set to θ<45° (0°<θ). In this embodiment, as an example, the end 60 that satisfies 0°<θ<45° is formed. A method of forming sidewall patterns is explained below.

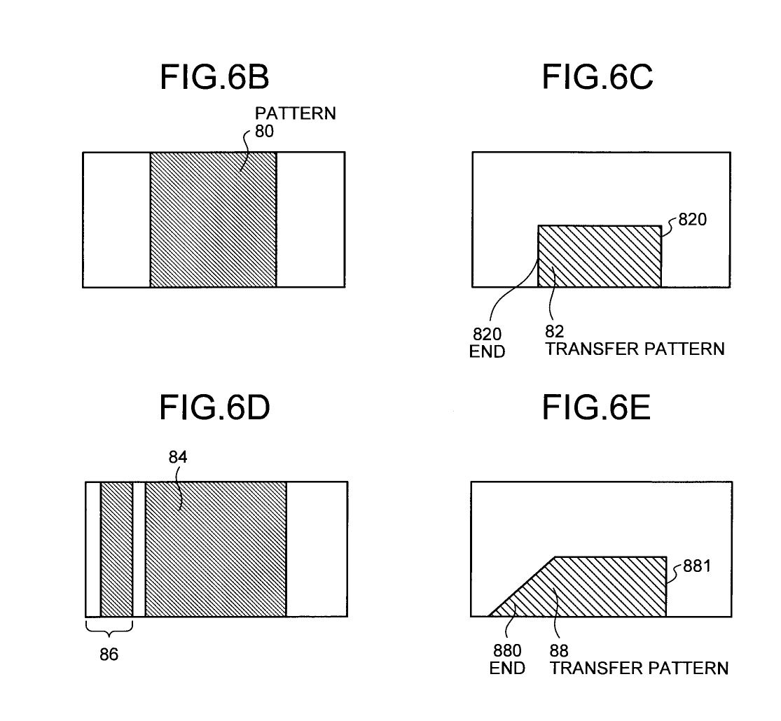

FIGS. 5A, 5D, and 5G are top views of the end of the transfer pattern. FIG. 5B is a sectional view in a position taken along line V(b)-V(b) shown in FIG. 5A. FIG. 5C is a sectional view in a position taken along line V(c)-V(c) shown in FIG. 5A. FIG. 5E is a sectional view in the position taken along line V(e)-V(e) shown in FIG. 5D. FIG. 5F is a sectional view in a position taken along line V(f)-V(f) shown in FIG. 5D. FIG. 5H is a sectional view taken along a position taken along line V(h)-V(h) shown in FIG. 5G. FIG. 5I is a sectional view in a position taken along line V(i)-V(i) shown in FIG. 5G.

First, as shown in FIGS. 5A, 5B, and 5C, the transfer pattern 6 is formed on a mask film 5, which is formed on the semiconductor substrate, by the photolithography method or the like.

Subsequently, as shown in FIGS. 5D, 5E, and 5F, the sidewall material film 7 is formed to cover the transfer pattern 6, by the CVD method or the like.

As shown in FIGS. 5G, 5H, and 51, the sidewall material film 7 is etched back with an etch-back amount larger than the film thickness Y by the reactive ion etching (RIE) method or the like to form sidewall patterns 70. The sidewall patterns 70 do not form a closed loop because the distal end of the end 60 is cut as shown in FIG. 5G. Formation of the shape of the end for cutting the closed loop is explained below.

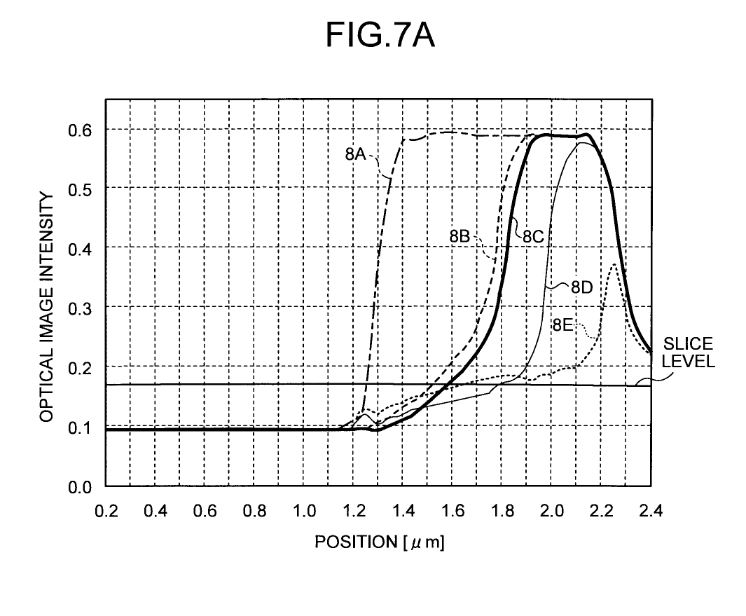

FIG. 6A is a graph of changes in optical image intensity that occur when auxiliary patterns are arranged near an end of a pattern formed on a photomask and when the auxiliary patterns are not arranged and a diagram of the upper surface of the auxiliary patterns arranged near the end of the pattern. FIG. 6B is a top view of a mask pattern, near an end of which the auxiliary patterns are not arranged. FIG. 6C is a sectional view of a transfer pattern transferred by using the mask pattern, near the end of which the auxiliary patterns are not arranged. FIG. 6D is a top view of a mask pattern, near an end of which the auxiliary patterns are arranged. FIG. 6E is a sectional view of a transfer pattern transferred by using the mask pattern, near the end of which the auxiliary patterns are arranged. In the graph shown in FIG. 6A, the abscissa represents the position (μm) of the pattern on the semiconductor substrate and the ordinate represents the optical image intensity. A profile 8a shown in the graph is a curve of the optical image intensity obtained when the auxiliary patterns are not arranged near the end of the pattern. A profile 8b is a curve of the optical image intensity obtained when the auxiliary patterns are arranged near the end of the pattern. A transfer pattern 82 and a transfer pattern 88 indicate, for example, transfer patterns formed on the film on the semiconductor substrate.

When the auxiliary patterns are not arranged at an end of a pattern 80 as shown in FIG. 6B, as shown in the graph of FIG. 6A, the optical image intensity of the profile 8a steeply changes near the end of the pattern 80 (e.g., 2.4 micrometers to 2.6 micrometers). This change indicates that, as shown in FIG. 6C, an end 820 of the transfer pattern 82, which is a pattern formed by transferring the pattern 80, is substantially perpendicularly formed.

When sidewall patterns are formed around the transfer pattern 82 using the transfer pattern 82 as a core material pattern, the sidewall patterns are formed around the transfer pattern 82 such that the height from the film under the transfer pattern 82 to the vertexes of the sidewall patterns is substantially fixed. Therefore, a process by the photolithography method for cutting a closed loop formed by the sidewall patterns is necessary.

On the other hand, when auxiliary patterns 86 are arranged at one end of a pattern 84 as shown in FIGS. 6A and 6D, as shown in the graph of FIG. 6A, the optical image intensity of the profile 8b gently changes near the end of the pattern 84 (e.g., 2.15 micrometers to 2.6 micrometers) compared with the profile 8a. This gentle change indicates that, as shown in FIG. 6E, a slope is formed at an end 880 on a side on which the auxiliary patterns 86 are arranged of the transfer pattern 88, which is a pattern formed by transferring the pattern 84. As shown in FIG. 6E, an end 881 of the transfer pattern 88 on a side on which the auxiliary patterns 86 are not arranged is substantially perpendicularly formed.

The auxiliary patterns 86 are formed by, for example, changing an L (line)/S (space) ratio stepwise at a pitch (e.g., fixed to a dimension of 60 nanometers on a wafer) smaller than an exposure resolution limit. Because the pitch of the auxiliary patterns 86 are smaller than the exposure resolution limit, the patterns are not accurately transferred. Therefore, according to an optical proximity effect realized by arranging the auxiliary patterns 86 near the end of the pattern 84, it is possible to control the optical image intensity near the end and form a desired slope at the end 880.

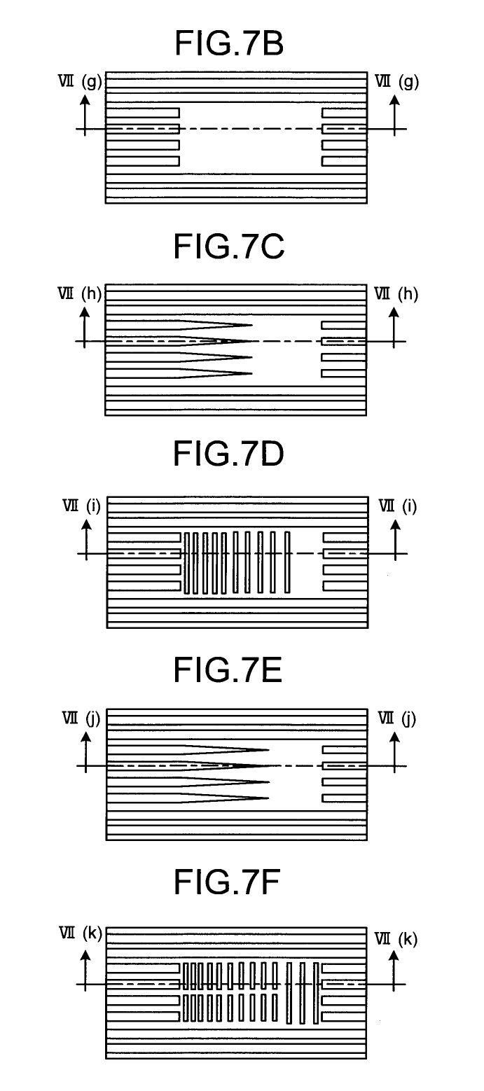

FIG. 7A is a graph of optical image intensities near ends of transfer patterns formed by transferring patterns shown in FIGS. 7B to 7F. In FIG. 7B, sub-resolution assist feature (SRAF) patterns are not arranged at the ends. In FIG. 7C, the SRAF patterns are connected to the ends. In FIG. 7D, the SRAF patterns are arranged orthogonal to the ends. In FIG. 7E, the ends shown in FIG. 7C are formed slimmer. In FIG. 7F, a part of the patterns shown in FIG. 7D is divided. FIG. 7G is a sectional view of the optical image intensity of the transfer pattern in a position taken along line VII(g)-VII(g) shown in FIG. 7B. FIG. 7H is a sectional view of the optical image intensity of the transfer pattern in a position taken along line VII(h)-VII(h) shown in FIG. 7C. FIG. 7I is a sectional view of the optical image intensity of the transfer pattern in a position taken along line VII(i)-VII(i) shown in FIG. 7D. FIG. 7J is a sectional view of the optical image intensity of the transfer pattern in a position taken along line VII(j)-VII(j) shown in FIG. 7E. FIG. 7K is a sectional view of the optical image intensity of the transfer pattern in a position taken along line VII(k)-VII(k) shown in FIG. 7F. In FIG. 7A, the ordinate represents the optical image intensity and the abscissa represents the position (μm). The position corresponds to the sectional views of the patterns of FIGS. 7G to 7K.

In the case of normal ends at which the SRAF patterns are not arranged shown in FIG. 7B, as shown in FIG. 7A, a profile 8A steeply changes near the ends (e.g., 1.2 micrometers to 1.4 micrometers). Therefore, as shown in FIG. 7G, the ends of the transferred patterns are substantially perpendicularly formed.

In the case of the SRAF connection shown in FIG. 7C, as shown in FIG. 7A, a profile 8B gently changes near the ends (e.g., 1.2 micrometers to 1.9 micrometers). According to the change, as shown in FIG. 7H, gentle slopes are formed at the ends of the transferred patterns. The SRAF connection means that, for example, the SRAF patterns with the width thereof gradually narrowed are connected to the ends.

In the case of the SRAF arrangement (a duty ratio is changed) shown in FIG. 7D, as shown in FIG. 7A, a profile 8C gently changes near the ends (e.g., 1.2 micrometers to 1.95 micrometers) in the same manner as the profile 8B. According to the change, as shown in FIG. 7H, gentler slopes are formed at the ends of the transferred patterns compared with the ends shown in FIG. 7H. In the SRAF arrangement, for example, spaces among the SRAF patterns are increased further away from the ends.

When the ends of the SRAF connection are formed slimmer as shown in FIG. 7E, as shown in FIG. 7A, a profile 8D more gently changes near the ends (e.g., 1.2 micrometers to 2.1 micrometers) compared with the profiles 8A to 8C. According to the change, as shown in FIG. 7J, gentle slopes are formed at the ends of the transferred patterns.

When a part of the SRAF patterns shown in FIG. 7D is divided as shown in FIG. 7F, as shown in FIG. 7A, a profile 8E gently changes near the ends (e.g., 1.2 micrometers to 2.25 micrometers) compared with the profiles 8A to 8D and the optical image intensity further falls. Because the optical image intensity falls, as shown in FIG. 7K, gentle slopes are formed over a long distance at the ends of the transferred patterns.

Because the SRAF patterns are arranged as the auxiliary patterns at ends of core material patterns as explained above, sections of the ends of the transfer patterns formed by transferring the core material patterns are formed in a tilting shape. For example, when viewed from above, the ends of the transfer patterns are tapered at the distal ends and formed in a taper shape like a tip portion of a cone.

The simulation section 200c changes conditions such as arrangement of the auxiliary patterns, the number of the auxiliary patterns, and the shape of the auxiliary patterns and performs simulation of sidewall pattern formation such that, for example, the ends of the transfer patterns are formed in a taper shape for cutting a closed loop.

A method of forming a taper shape of the end 60 is not limited to the above. For example, the transmittance, the phase difference, the illumination shape, the polarization, or the like of the photomask 4 can be used independently or in combination to form the taper shape.

A method of generating a mask pattern according to the first embodiment is explained below.

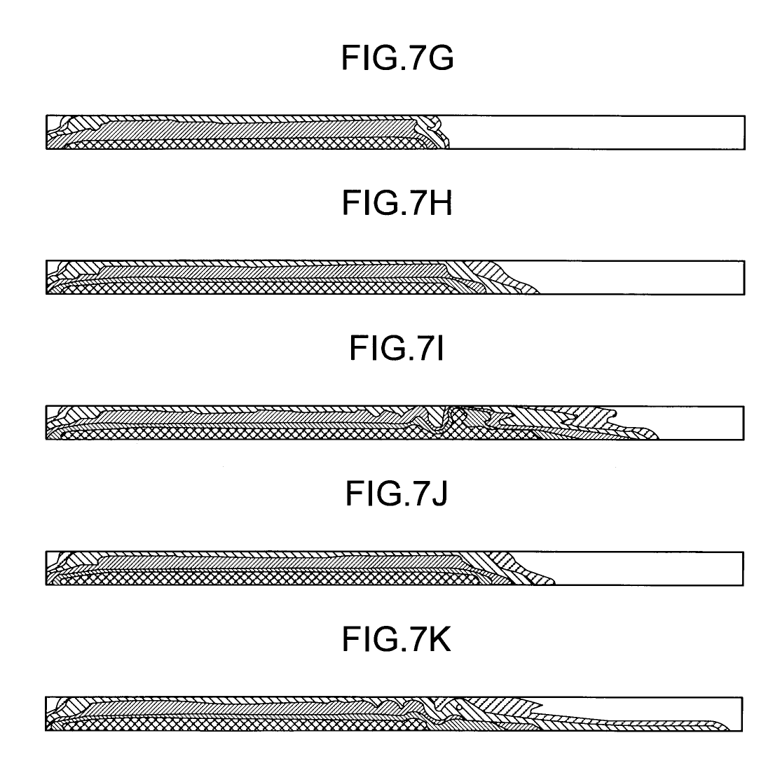

FIG. 8 is a flowchart for explaining the method of generating a mask pattern according to the first embodiment. An example of a process until generation of a mask pattern is explained according to the flowchart of FIG. 8.

First, the CPU 100 of the computer 1 reads out the computer program 200 from the storing unit 20. The CPU 100 causes the RAM 101 to store the computer program 200 and starts processing according to the computer program 200.

Subsequently, the core-material-pattern acquiring section 200a acquires the layout data 201 from the storing unit 20 (step S1).

The core-material-pattern acquiring section 200a acquires a core material pattern from the layout data 201 (step S2).

The DRC section 200b determines whether the core material pattern acquired from the core-material-pattern acquiring section 200a conforms to design rules. When the DRC section 200b determines that the core material pattern conforms to the design rules (“OK” at step S3), the DRC section 200b advances the processing to the next step S4.

When the DRC section 200b determines that the core material pattern does not conform to the design rules (“NG” at step S3), for example, the core-material-pattern acquiring section 200a returns to step S2, changes acquisition conditions, and acquires a core material pattern from the layout pattern 201. When a core material pattern satisfying the design rules is not obtained even if the acquisition conditions are changed, the core-material-pattern acquiring section 200a returns to step S1 and changes the layout data 201 such that a core material pattern satisfies the design rules.

The simulation section 200c performs simulation of sidewall pattern formation and extracts a core material pattern corresponding to a transfer pattern around which sidewall patterns form a closed loop (step S4). For example, when a closed loop is not extracted, the simulation section 200c advances the processing to step S9 or step S10.

The simulation section 200c performs simulation for arranging auxiliary patterns near an end of the extracted core material pattern and transferring the core material pattern to a transfer target. The simulation section 200c performs calculation of a transfer pattern formed in a taper shape (step S5) and calculation of a transfer pattern formed in a non-taper shape (step S6). In the simulation, the simulation section 200c simulates a process for transferring a mask pattern to a resist as the core material pattern. As the mask pattern, a mask pattern that should be formed on a photomask such as a mask pattern obtained by subjecting the extracted core material pattern to a lithography process, a slimming process, and an etching process is prepared. Formation of the transfer pattern is a process for, after forming a core material pattern on a resist film using the photolithography, transferring the core material pattern to a transfer target in a base through the etching process while slimming the core material pattern through the slimming process.

The simulation section 200c determines the shape of the end formed in the calculated taper shape (step S7) and determines the shape of the transfer pattern formed in the calculated non-taper shape (step S8). The determination of the shape of the transfer pattern formed in the non-taper shape is, for example, determination whether the shape is a shape based on the layout data 201. The determination of the shape of the end formed in the taper shape is performed by a method explained below.

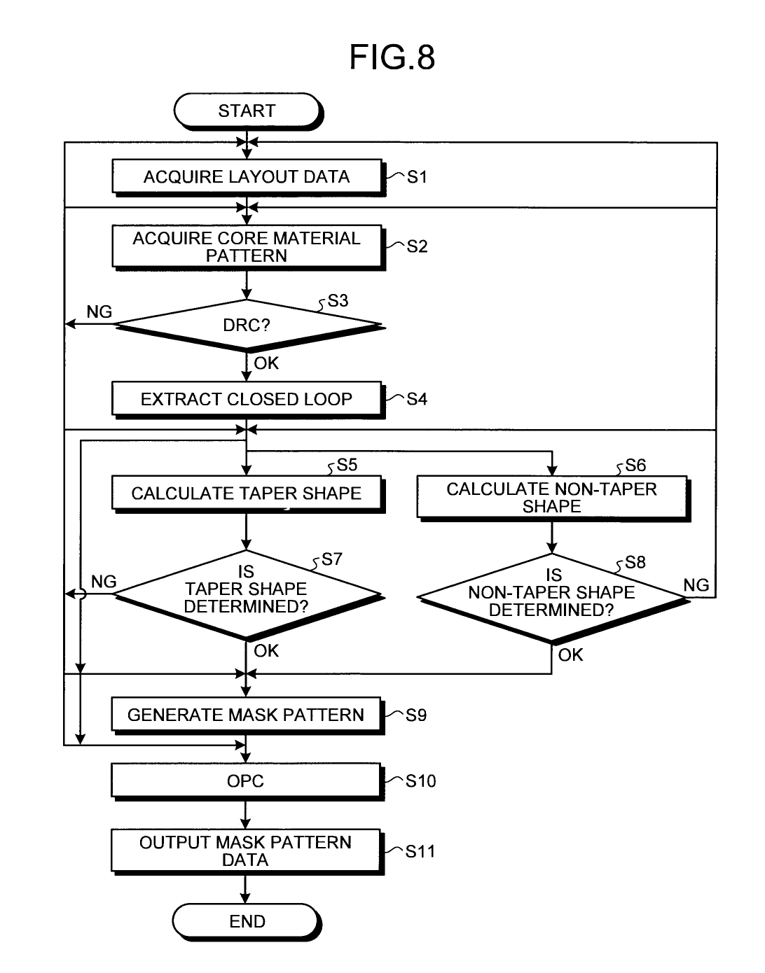

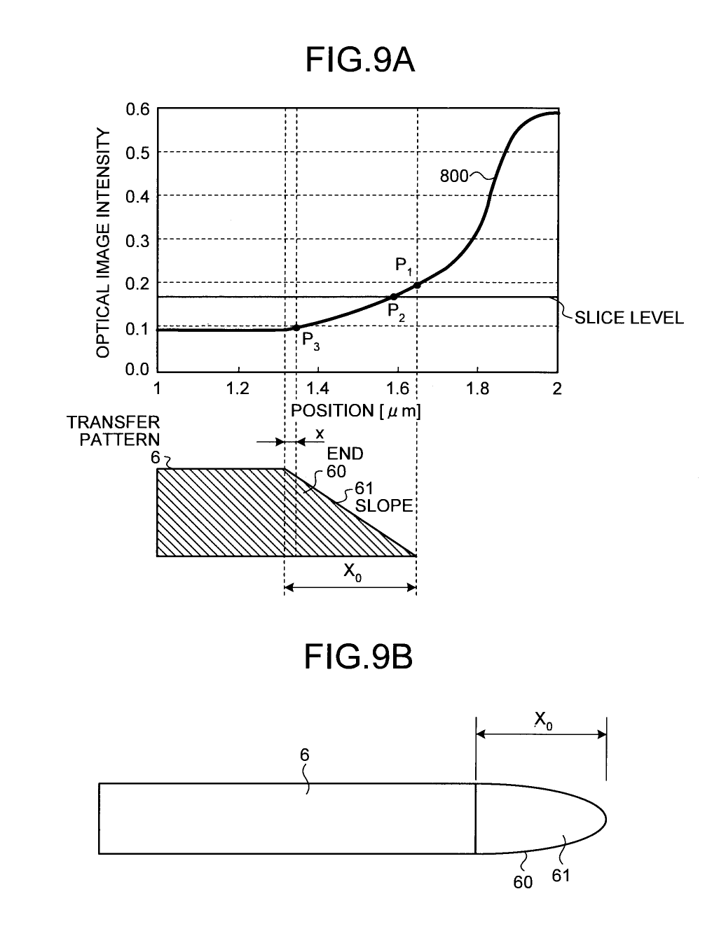

FIG. 9A is a graph concerning the position and the optical image intensity of the transfer pattern and a main part sectional view of the transfer pattern. FIG. 9B is a top view of the transfer pattern.

The simulation section 200c acquires a profile 800 of the optical image intensity shown in the graph of FIG. 9A. The profile 800 is obtained in the simulation for transferring the core material pattern to the transfer target.

The simulation section 200c calculates tilts at points P₁, P₂, and P₃ shown in the graph of FIG. 9A from the acquired profile 800.

As shown in FIG. 9A, the point P₁ is a point on the profile 800 corresponding to the distal end portion of the end 60 of the transfer pattern 6.

As shown in FIG. 9A, the point P₂ is an intersection of a slice level (e.g., optical image intensity of 0.16) and the profile 800. The slice level is, for example, optical image intensity set as a target in actually performing exposure processing.

The point P₃ is a point on the profile 800 corresponding to a position apart from a vertex by a fixed distance x in the horizontal direction toward the end. The horizontal direction indicates a direction horizontal to FIG. 8.

The simulation section 200c calculates, from the tilts of the profile 800 at the three points P₁, P₂, and P₃ and the sectional shape of the transfer pattern 6, f(Slope) with which the following Formula (2) holds.

X₀=X+f(Slope) (2)

X₀ is a distance in the horizontal direction from the beginning to the end of the slope 61 of the transfer pattern 6 shown in FIGS. 9A and 9B. f(Slope) is a function calculated in advance based on an end shape formed in a desired taper shape by an experiment, simulation, or the like. The determination and the like explained above can be applied to, for example, an end of the core material pattern formed on the resist film.

The simulation section 200c determines, with X₀ satisfying the condition concerning the angle θ of the end 60 of the transfer pattern 6 set as a threshold, whether the taper shape is a shape that can cut a closed loop.

When results of the determination of the taper shape and the non-taper shape are OK at steps S7 and S8 (“OK” at steps S7 and S8), i.e., when the simulation section 200c determines that the sidewall patterns do not form a closed loop, the simulation section 200c adopts the mask pattern used for the simulation. The mask-pattern-generating unit 200d generates the mask pattern data 23 of the photomask based on arrangement of the auxiliary patterns for forming the end of the transfer pattern in a shape for cutting a closed loop (step S9).

When a result of the determination of the taper shape is NG at step S7 (“NG” at step S7), i.e., when the obtained core material pattern does not have the desired taper shape or when a closed loop of the obtained sidewall patterns is not cut, the simulation section 200c changes the mask pattern, for example, changes conditions such as an OPC condition and arrangement of the auxiliary patterns and performs simulation core material pattern formation or sidewall pattern formation again. When the closed loop is not cut even if the simulation of sidewall pattern formation is performed based on all conditions such as a predetermined number of times of change of the mask pattern and arrangement of effective auxiliary patterns, the simulation section 200c changes the acquisition conditions and acquires a design core material pattern again via the core-material-pattern acquiring section 200a. Further, for example, when the closed loop is not cut by the simulation of sidewall pattern formation even if the acquisition conditions for the design core material pattern is changed a predetermined number of times or all effective acquisition conditions are changed, the simulation section 200c changes the layout data 201. However, the mask-pattern generating section 200d can change the layout data 201 without necessarily changing the core material pattern acquisition condition and performing the verification again through the simulation. For example, when the closed loop is not cut, the simulation section 200c can change process conditions in the core material pattern formation and the sidewall pattern formation.

When a result of the determination of the non-taper shape is NG at step S8 (“NG” at step S8), for example, the simulation section 200c executes step S6 when the simulation section 200c changes the conditions and performs the simulation of sidewall pattern formation again. For example, the simulation section 200c executes step S2 when the non-taper shape is not formed even if the simulation section 200c performs the simulation based on the predetermined number of times of change of the conditions or all the effective conditions in the simulation of sidewall pattern formation. For example, the simulation section 200c executes step S1 when the non-taper shape is not formed even if the acquisition condition is changed the predetermined number of times or all the effective acquisition conditions are changed.

The OPC section 200e performs optical proximity correction based on the mask pattern data 23 and corrects the mask pattern data 23 using a necessary correction pattern (step S10).

The CPU 100 outputs the corrected mask pattern data 23 via the output unit 14 (step S11) and ends the operation.

Subsequently, the photomask manufacturing apparatus manufactures the photomask 4 based on the mask pattern data 23 acquired from the computer 1. Subsequently, an exposure apparatus manufactures a semiconductor device using the photomask 4 manufactured by the photomask manufacturing apparatus 3. An example of a method of manufacturing a semiconductor device using the photomask 4 manufactured by the method explained above is explained below.

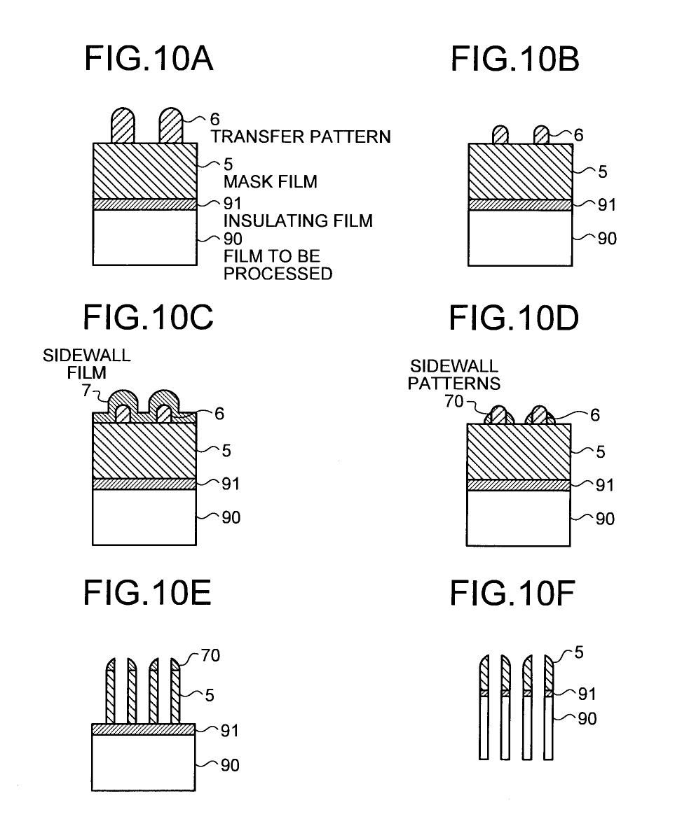

FIGS. 10A to 10F are main part sectional views for explaining a process for manufacturing a semiconductor device using a photomask according to the first embodiment.

First, a film to be processed 90, an insulating film 91, and the mask film 5 are formed on a semiconductor substrate in order.

The semiconductor substrate is an Si substrate containing Si as a main component.

The film to be processed 90 is, for example, a polycrystal Si film formed by the CVD method or the like.

The insulating film 91 is, for example, an SiN film formed by the CVD method or the like.

The mask film 5 is, for example, an SiC film formed by the CVD method or the like.

Subsequently, as shown in FIG. 10A, transfer patterns 6 are formed on the mask film 5 by the photolithography method or the like. An end of a transfer pattern, sidewall patterns formed around which form a closed loop, is formed in a taper shape, for example, as shown in FIGS. 9A and 9B.

The transfer patterns 6 are made of, for example, a resist material such as an ArF resist or a KrF resist.

As shown in FIG. 10B, the transfer patterns 6 are slimmed.

As a method for the slimming, for example, a method by plasma etching with O₂ or a method of forming the surface of a core material pattern to be alkali-soluble using an acid chemical, developing the core material pattern with tetramethyl ammonium hydroxide (TMAH) solution, and subsequently performing pure water rinse treatment to slim the core material pattern is used.

As shown in FIG. 10C, the sidewall material film 7 is formed to cover the transfer patterns 6 by the CVD method or the like.

The sidewall material film 7 is, for example, an SiO₂ film.

As shown in FIG. 10D, the sidewall material film 7 is etched by the RIE method or the like to form the sidewall patterns 70. In the sidewall patterns 70, closed loops are cut because the ends of the transfer patterns 6 are formed in a taper shape.

As shown in FIG. 10E, the transfer patterns 6 are removed by ashing or the like. Subsequently, the mask film 5 is etched by the RIE method or the like using the sidewall patterns 70 as masks.

As shown in FIG. 10F, the insulating film 91 and the film to be processed 90 are etched by the RIE method or the like using the sidewall patterns 70 and the mask film 5 as masks.

The mask film 5 and the insulating film 91 are removed to obtain line and space patterns formed by the film to be processed 90. Subsequently, a desired semiconductor device is obtained through a well-known process.

According to the first embodiment, effects explained below are obtained.

(1) An end of a core material pattern or a transfer pattern that forms a closed loop through formation of sidewall patterns has a shape for cutting the closed loop. Therefore, compared with cutting the closed loop using the photolithography method, the number of steps is reduced because the closed loop is cut when the sidewall patterns are formed. Because the number of steps is small, it is possible to reduce manufacturing cost for a semiconductor device.

(2) The computer 1 executes the computer program 200 for forming the shape of the end of the core material pattern or the transfer pattern in a taper shape. Therefore, compared with generating mask pattern data without executing a computer program for forming the shape of the end of the core material pattern or the transfer pattern in a taper shape, it is possible to easily generate the mask pattern data 23 of the photomask in which the shape of the end of the core material pattern or the transfer pattern is formed in a taper shape.

(3) The computer program 200 performs determination of a taper shape of the end of the core material pattern or the transfer pattern around which the closed loop needs to be cut and the determination of a non-taper shape of the ends that does not need to be formed in a taper shape. Therefore, compared with not performing the determination of the non-taper shape, it is possible to prevent the end at which the closed loop does not need to be cut from being formed in a taper shape. The yield of a semiconductor device is improved.

A second embodiment is explained below. The second embodiment is different from the first embodiment in that the optical proximity correction is performed in the next step of the determination of design rules. In the second embodiment, components having configurations and functions same as those in the first embodiment are denoted by the same reference numerals and signs and explanation of the components is omitted.

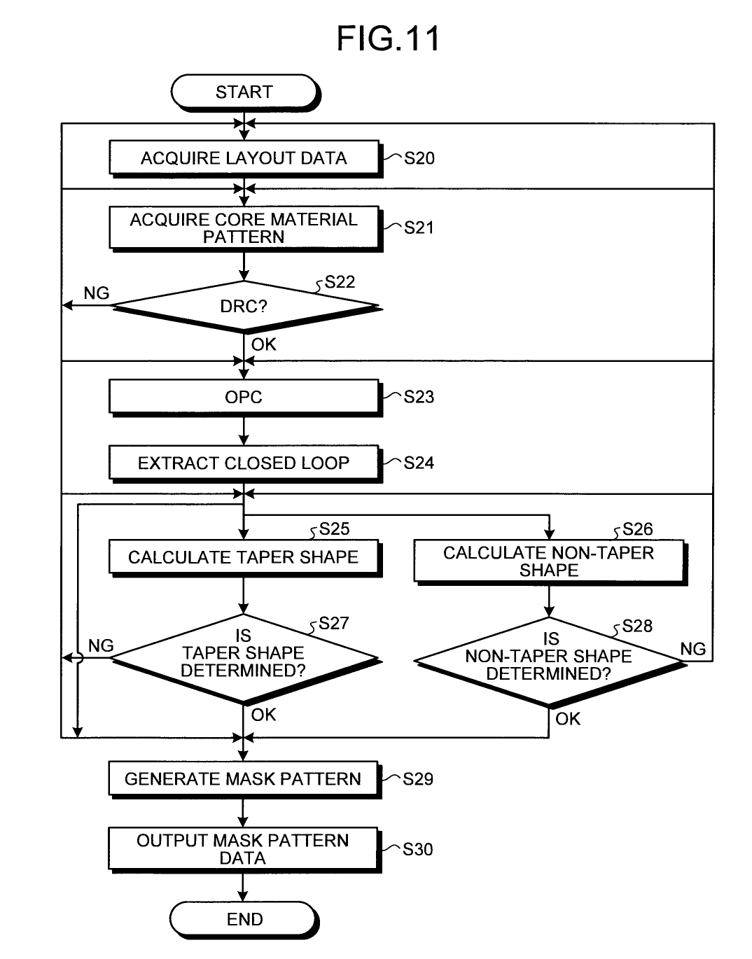

FIG. 11 is a flowchart for explaining a method of generating a mask pattern according to the second embodiment.

Steps S20 to S22 are executed in the same manner as steps S1 to S3 in the first embodiment.

Subsequently, the OPC section 200e performs the optical proximity correction based on the core material pattern acquired at step S21 and corrects the core material pattern using a necessary correction pattern (step S23).

The following steps S24 to S28 are executed in the same manner as steps S4 to S8 in the first embodiment. For example, when a closed loop is not extracted at step S24, the simulation section 200c advances the processing to step S29.

Step S29 is executed in the same manner as step S9 in the first embodiment. Step S30 is executed in the same manner as step S11 in the first embodiment.

Subsequently, a photomask manufacturing apparatus manufactures the photomask 4 based on the mask pattern data 23 acquired from the computer 1. An exposure apparatus manufactures a semiconductor device using the photomask 4 manufactured by the photomask manufacturing apparatus.

According to the second embodiment, a condition under which an end of a core material pattern or a transfer pattern is formed in a shape for cutting a closed loop is calculated based on a design core material pattern corrected by using a correction pattern based on the optical proximity correction. Therefore, compared with performing the optical proximity correction after a mask pattern of a photomask is determined, a change in a taper shape of the end of the core material pattern or the transfer pattern involved in the optical proximity correction can be prevented. Because a change in the taper shape of the end is prevented, it is possible to accurately cut the closed loop. The yield of a semiconductor device is improved.

The present invention is not limited to the embodiments explained above. Various modifications and combinations are possible without departing from or changing the technical idea of the present invention.

For example, the computer 1 can be incorporated in the photomask manufacturing apparatus.

For example, a part of the flowcharts shown in FIGS. 8 and 11 or the entire flowcharts can be executed by hardware.

Further, for example, the steps shown in FIGS. 8 and 11 are not limited to the order explained above. The steps can be interchanged without departing from or changing the technical idea of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of generating a mask pattern comprising:
acquiring a core material pattern from layout data of a circuit pattern;
performing, using a mask pattern for forming the core material pattern, process simulation for calculating any one of the core material pattern, a transfer pattern formed by transferring the core material pattern, and sidewall patterns formed on sidewalls of the core material pattern or the transfer pattern and verifying whether the sidewall patterns formed on the sidewalls of the core material pattern or the transfer pattern form a closed loop; and
changing the mask pattern when it is determined as a result of the verification that the sidewall patterns form a closed loop and adopting the mask pattern when it is determined as a result of the verification that the sidewall patterns do not form a closed loop.

2. The method of generating a mask pattern according to claim 1, wherein the verification is carried out by determining whether a shape of the core material pattern or the transfer pattern is a desired taper shape.

3. The method of generating a mask pattern according to claim 1, wherein the change of the mask pattern is carried out by changing a shape or arrangement of auxiliary patterns of the mask pattern.

4. The method of generating a mask pattern according to claim 1, wherein the change of the mask pattern is carried out by changing the layout data.

5. The method of generating a mask pattern according to claim 1, further comprising:
extracting the core material pattern corresponding to the transfer pattern around which the sidewall patterns form a closed loop;
performing simulation for arranging the auxiliary patterns near an end of the extracted core material pattern and transferring the core material pattern to a transfer target; and
performing calculation of a transfer pattern in which the end is formed in a taper shape and calculation of a transfer pattern in which the end is formed in a non-taper shape.

6. The method of generating a mask pattern according to claim 1, further comprising correcting the core material pattern using a correction pattern based on optical proximity correction and verifying whether the sidewall patterns form a closed loop.

7. A mask pattern generating program for causing a computer to execute:
a procedure for acquiring a core material pattern from layout data of a circuit pattern;
a procedure for verifying whether sidewall patterns formed on sidewalls of the core material pattern or a transfer pattern formed by transferring the core material pattern form a closed loop, the core material pattern, the transfer pattern, and the sidewall patterns being calculated by process simulation performed by using a mask pattern for forming the core material pattern; and
a procedure for changing the mask pattern when it is determined as a result of the verification that the sidewall patterns form a closed loop and adopting the mask pattern when it is determined as a result of the verification that the sidewall patterns do not form a closed loop.

8. The mask pattern generating program according to claim 7, wherein the verification is carried out by determining whether a shape of the core material pattern or the transfer pattern is a desired taper shape.

9. The mask pattern generating program according to claim 7, wherein the change of the mask pattern is carried out by changing a shape or arrangement of auxiliary patterns of the mask pattern.

10. The mask pattern generating program according to claim 7, wherein the change of the mask pattern is carried out by changing the layout data.

11. The mask pattern generating program according to claim 7, further causing the computer to execute:
a procedure for extracting the core material pattern corresponding to the transfer pattern around which the sidewall patterns form a closed loop;
a procedure for performing simulation for arranging the auxiliary patterns near an end of the extracted core material pattern and transferring the core material pattern to a transfer target; and
a procedure for performing calculation of a transfer pattern in which the end is formed in a taper shape and calculation of a transfer pattern in which the end is formed in a non-taper shape.

12. The mask pattern generating program according to claim 7, further causing the computer to execute:
a procedure for correcting the core material pattern using a correction pattern based on optical proximity correction; and
a procedure for verifying whether the sidewall patterns form a closed loop.

13. A method of manufacturing a semiconductor device, comprising:
acquiring a core material pattern from layout data of a circuit pattern;
performing, using mask pattern data for forming the core material pattern, process simulation for calculating any one of the core material pattern, a transfer pattern formed by transferring the core material pattern, and sidewall patterns formed on sidewalls of the core material pattern or the transfer pattern and verifying whether the sidewall patterns formed on the sidewalls of the core material pattern or the transfer pattern form a closed loop;
changing the mask pattern data when it is determined as a result of the verification that the sidewall patterns form a closed loop and adopting the mask pattern data when it is determined as a result of the verification that the sidewall patterns do not form a closed loop; and
using a photomask that includes a mask pattern generated based on the mask pattern date.

14. The method of manufacturing a semiconductor device according to claim 13, wherein the verification is carried out by determining whether a shape of the core material pattern or the transfer pattern is a desired taper shape.

15. The method of manufacturing a semiconductor device according to claim 13, wherein the change of the mask pattern date is carried out by changing a shape or arrangement of auxiliary patterns of the mask pattern.

16. The method of manufacturing a semiconductor device according to claim 13, wherein the change of the mask pattern date is carried out by changing the layout data.

17. The method of manufacturing a semiconductor device according to claim 13, further comprising:
extracting the core material pattern corresponding to the transfer pattern around which the sidewall patterns form a closed loop;
performing simulation for arranging the auxiliary patterns near an end of the extracted core material pattern and transferring the core material pattern to a transfer target; and
performing calculation of a transfer pattern in which the end is formed in a taper shape and calculation of a transfer pattern in which the end is formed in a non-taper shape.

18. The method of manufacturing a semiconductor device according to claim 13, further comprising:
correcting the core material pattern using a correction pattern based on optical proximity correction; and
verifying whether the sidewall patterns form a closed loop.
